(19) United States
(12) Patent Application Publication
(10) Pub. No.: US 2026/0052380 A1
(43) Pub. Date: Feb. 19, 2026

(54) MITIGATING NONCE REUSE RISKS WITH SHARED KEY

(71) Applicant: Cisco Technology, Inc., San Jose, CA (US)

(72) Inventors: Brian D. HART, Sunnyvale, CA (US); Binita GUPTA, San Diego, CA (US); Stephen M. ORR, Wallkill, NY (US)

(21) Appl. No.: 19/281,649

(22) Filed: Jul. 26, 2025

Related U.S. Application Data
(60) Provisional application No. 63/684,753, filed on Aug. 19, 2024.

(51) Int. Cl. H04W 12/041; H04W 36/08; H04W 84/12

(52) U.S. Cl. CPC H04W 12/041; H04W 36/08; H04W 84/12

(57) ABSTRACT

A wireless device comprising one or more memories and one or more processors communicatively coupled to the one or more memories. The one or more processors are configured, individually or collectively, to perform an operation. The operation comprises initiating a roam between a first access point (AP) and a second AP. After the roam, the operation further comprises detecting that the first AP reused a packet number (PN) that the second AP had used, and based on detecting that the first AP reused the PN, establishing a new pairwise transient key (PTK) with the first AP.

### CROSS-REFERENCE TO RELATED APPLICATIONS

This application claims benefit of co-pending U.S. provisional patent application Ser. No. 63/684,753 filed Aug. 19, 2024. The aforementioned related patent application is herein incorporated by reference in its entirety.

### TECHNICAL FIELD

Embodiments presented in this disclosure generally relate to computer networking. More specifically, embodiments disclosed herein relate to mitigating reuses when roaming between access points in a wireless network.

### BACKGROUND

In Wi-Fi networks, nonces play a significant security role. A nonce or “number used once” is a value that is generated for single, unique use in a cryptographic protocol. For example, some nonces are randomly or pseudo-randomly generated and used in cryptographic operations. By maintaining uniqueness, nonces prevent attackers from replaying old messages or perform other cryptographic attacks and compromising the network. As such, unintentional nonce reuses should be avoided. For example, buggy implementations that result in reuse may create a major security hole in the network. This constraint makes it difficult to configure a seamless roaming experience.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system for mitigating reuse during roaming and establishing a new pairwise transient key (PTK), according to an embodiment.

FIG. 2A illustrates a method of mitigating reuse performed by a wireless device, according to an embodiment.

FIG. 2B illustrates a method of mitigating reuse performed by an access point (AP), according to an embodiment.

FIG. 2C illustrates a method of performing a rekey during roaming by a wireless device, according to another embodiment.

FIG. 3 illustrates a swim-lane diagram of an edge case that occurs during roaming, according to an embodiment.

FIG. 4A illustrates a swim-lane diagram for mitigating a reuse during roaming, to an embodiment.

FIG. 4B illustrates a swim-lane diagram for mitigating reuse during roaming, according to another embodiment.

FIG. 4C illustrates a swim-lane diagram for establishing a new PTK during roaming, according to yet an embodiment.

FIG. 5 illustrates hardware of a special purpose computing system 500 configured according to the above disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure relates to a wireless device including one or more memories and one or more processors communicatively coupled to the one or more memories, where the one or more processors are configured, individually or collectively, to perform an operation. The operation includes initiating a roam between a first access point (AP) and a second AP. The operation further includes detecting, after the roam, that the first AP reused a packet number (PN) that the second AP had used. The operation further includes, based on detecting that the first AP reused the PN, establishing a new pairwise transient key (PTK) with the first AP.

One embodiment presented in this disclosure relates to an access point including one or more memories and one or more processors communicatively coupled to the one or more memories, where the one or more processors are configured, individually or collectively, to perform an operation. The operation includes detecting that a device initiated a roam to the AP. The operation further includes detecting, after the roam, that the device reused a PN. The operation further includes, based on the detecting that the device reused the PN, establishing a new PTK with the device.

One embodiment presented in this disclosure relates to a wireless device including one or more memories and one or more processors communicatively coupled to the one or more memories, where the one or more processors are configured, individually or collectively, to perform an operation. The operation includes determining that a roam from a first AP to a second AP should be performed, and based on determining that the roam should be performed, performing a rekey with the first AP to establish a new PTK. The operation further includes exchanging encrypted messages with the second AP using the new PTK.

### EXAMPLE EMBODIMENTS

Embodiments disclosed herein relate to mitigating reuses when roaming between access points (APs) in a wireless network. Roaming may refer to a device's ability to switch between different APs to obtain a stronger RF connection. Of major concern in roaming is security, namely with respect to cryptographic keys. For a roam to be truly “seamless” or near seamless, there should be no loss in connection or noticeable interruption in service. In one approach, a shared pair-wise transient key (PTK) is used across a seamless mobility domain (SMD), which may include multiple APs. However, preserving security becomes more difficult when the PTK is shared across multiple APs. This is especially true for certain edge cases, such as when a wireless device continuously switches or roams back and forth between APs over a short period of time. In such cases, vulnerability to cryptographic attacks increases due to potential reuses in packet numbers (PNs), nonces, or other data elements used for encrypted messaging.

In embodiments, a PN is a monotonically increasing counter for each frame encrypted with a PTK. When communicating with a device (which may also be referred to as a station (STA) or a client), and a roam is initiated, the current serving AP multi-link device (MLD), AP1, uses PNs up to a downlink PN1, then tells the target AP MLD, AP2, to begin forming downlink frames using a PN starting at PN1+Delta, where Delta is some positive constant or buffer size value, e.g., 1024. To the extent that new media access control (MAC) Service Data Units (MSDUs) arrive at the current AP1 from the network before the roam completes, or to the extent that medium access control (MAC) management protocol data units (MMPDUs) are generated or received at the current AP1 before the roam completes, the current AP1 is able to send the messages as MAC Protocol Data Units (MPDUs) to the device for up to a fixed buffer (i.e., “Delta”) of additional MPDUs. After that, the current AP1 discards further MSDUs arriving from the network to avoid reuse of the PN or forwards the additional MSDUs to AP2 over an out-of-band communication channel (e.g., ethernet). Because the target AP2 uses PNs from PN1+Delta onwards, there may be no PN reuse for the shared PTK if the two AP MLDs are non-buggy. However, if an SMD implementation is buggy, immediate roams back to an AP may cause the AP to unintentionally reuse one or more PN values previously used before roaming.

To address these concerns, mitigations to reuse are provided in embodiments described herein. For example, in one embodiment, a device or STA detects a PN reuse when roaming. The detection of reuse may trigger the establishment of a new PTK, for example, by rekeying or reassociating with an AP. Additionally, in another embodiment, rekeying for the PTK may be initiated when an imminent need for a roam is detected.

In one embodiment, the device or STA monitors the use of PNs across AP1, AP2, and any other APs in the SMD. When the device detects a PN reuse across AP MLDs (e.g., the same PN is used by AP1 and AP2), the device may disassociate or deauthenticate and include an indicative reason code (e.g., ‘NONCE_REUSE’ or ‘REASON_INVALID_PAIRWISE_CIPHER’). The device may then associate with the AP MLD again (e.g., using robust security network (RSN)), and thereby establishes a fresh pairwise master key (PMK) and PTK that mitigates the PN reuse.

In one embodiment, if the device detects a PN reuse across AP MLDs within an SMD, the device may request a rekey of the PTK with the current AP MLD, thereby generating a new PTK that mitigates the PN reuse.

In one embodiment, if the device detects a PN reuse either one time, more than some number (N) greater than one times, or more than some number (M) out of N times, then the client may opt out of SMD roaming or decide to stop initiating SMD roaming.

In embodiments, PN or nonce reuse for a shared PTK at the device may be avoided because the same entity (e.g., device) is communicating with both AP1 and AP2. Also, a device may send the same MPDUs to the target AP2. If instead it is the device that is at fault, and the device reuses PNs (e.g., starts PN at 0 for a new AP MLD), then the target AP MLD may detect the reuse (e.g., PN is less than an uplink PN1+Delta) and disassociate/deauthenticate the device so that the device comes back and is assigned a new PTK in the same or similar manner as the buggy AP implementation described above. The PN1 and Delta used by the device need not be the same as the PN1 and Delta used by the AP MLD, as one may relate to an uplink and another may relate to a downlink.

In one embodiment, the device, upon detecting that a roam will be performed, first performs a rekey. Then a fresh, or at least “light used” PTK is used with the target AP. In one embodiment, rekeying before roaming may be limited to cases where the target AP has performed PN reuse in the past, where any AP in the SMD has performed PN reuse in the past, where other metrics or heuristics suggest that the APs of the SMD are at elevated risk of performing PN reuse, or cases where some combination of PN reuse and elevated risk of PN reuse is involved.

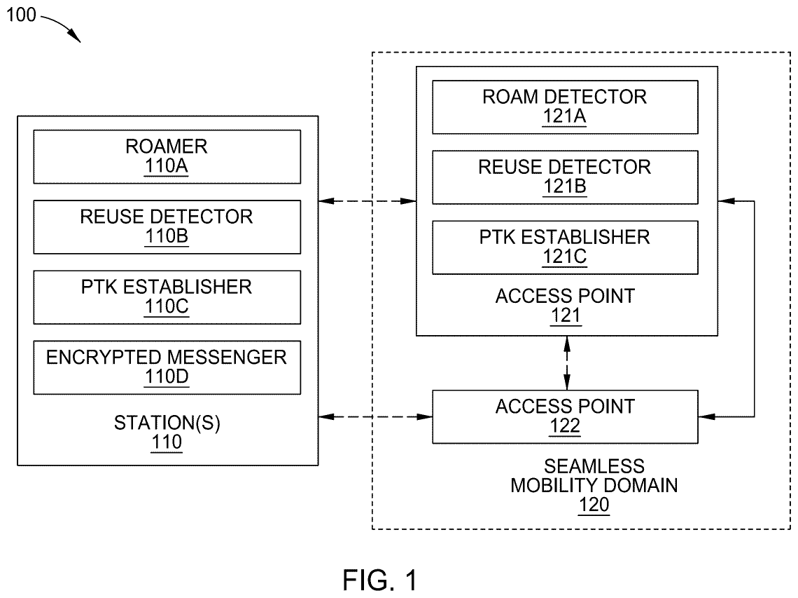

FIG. 1 illustrates a system 100 for mitigating reuse during roaming and establishing a new PTK, according to an embodiment. The system 100 includes at least one STA 110 and at least two APs 121 and 122 configured as part of a seamless mobility domain (SMD) 120. Although only one STA and two APs are shown, it should be understood that the SMD 120 may include more than two APs. Further, it should be understood that any number of STAs may be configured into the system, and each STA may roam between any number of APs of the SMD 120.

The STA 110 is a wireless device that connects to APs in a wireless network. For example, the STA 110 may be a mobile computing device or other wireless client device. The STA 110 includes one or processors and one or more memories. The one or more memories may include a roamer 110A, a reuse detector 110B, a PTK establisher 110C, and an encrypted messenger 110D.

The roamer 110A initiates roams between APs in the SMD 120, including roams between AP 121 and AP 122. For example, the roamer 110A may initiate a roam when signal strength becomes weaker at the current AP, but stronger at a target AP.

The reuse detector 110B monitors PNs and detects when a PN reuse has occurred. For example, when roaming between AP 121 and AP 122, the reuse detector 110B may detect that one of the APs transmits a PN that the other AP has already used or that is less than the PN set by the other AP that detects the roam. Furthermore, the reuse detector may detect that the PN reuse is not related to a retry of an earlier MPDU as allowed by a Block Ack agreement, which the reuse detector may determine based on Sequence Number, heuristics, or some combination thereof. In one embodiment, the reuse detector 110B may opt the STA 110 out of same-PTK roaming with the SMD 120 if the number of PN reuses detected at the SMD 120 are too large or too frequent. For example, the reuse detector 110B may determine a total number of PN reuses at the SMD 120, a number of reuses over a set number of tries, or a number of reuses over a period of time and compare the number of reuses to a predetermined threshold. If the number of PN reuses exceeds the threshold, the STA 110 may opt out of shared-PTK roaming. Therefore, the STA 110 may advantageously avoid roaming in an SMD 120 that is frequently buggy or insecure or revert to a form of roaming that does not involve a shared PTK (e.g., fresh transition roaming or the combination of disassociation and fresh association at a new AP MLD).

The PTK establisher 110C establishes PTKs, including new PTKs established as part of a reuse mitigation performed by the STA 110 during roaming. In one embodiment, the PTK establisher 110C may establish a new PTK by requesting a rekey with AP 121 or AP 122. In one embodiment, the PTK establisher 110C establishes a new PTK by disassociating and reassociating with an AP.

The encrypted messenger 110D exchanges encrypted messages with APs of the SMD 120, including AP 121 and AP 122. The encrypted messenger 110D encrypts the messages using a PTK, including a new PTK established as part of a reuse mitigation performed by the system 100 during roaming.

Each AP of the SMD 120 may be a multi-link device, where the AP may operate across multiple links or channels as part of a single connection between the AP and a STA (e.g., 2.4 GHz, 5 GHZ, 6 GHZ, etc.). AP 121 and AP 122 may communicate with the STA 110 and with each other via wireless communication (shown by dashed arrows) within a Wi-Fi network or other wireless local area network (WLAN) infrastructure. Furthermore, AP 121 and AP 122 may communicate with each other outside of the Wi-Fi network using an out-of-band communication channel (shown by the connecting solid arrow), such as a wired ethernet connection. AP 121 and AP 122 may each include one or processors and one or more memories. It should be understood that AP 122 may share some or all of the same features of AP 121, including the roam detector 121A, reuse detector 121B, and PTK establisher 121C, which are stored in one or more memories of the AP 121 and AP 122.

The roam detector 121A detects when a roam has been initiated by a STA. For example, an AP may determine that the STA 110 is no longer communicating with the AP and is exchanging messages with another AP in the SMD 120. Alternatively the AP may exchange explicit roaming execution messages with the STA 110.

The reuse detector 121B monitors PNs and detects when a STA reuses a PN. For example, the reuse detector 121B may detect that a PN received from the STA 110 is less than the PN set during the roam, such as when the STA 110 mistakenly restarts a packet number counter at 0 when the STA 110 roams to AP 121 or AP 122.

The PTK establisher 121C establishes PTKs to use with the STA 110, including new PTKs established as part of a reuse mitigation performed by the AP 121 or AP 122 during roaming. In one embodiment, PTK establisher 121C establishes a new PTK by initiating a rekey with the STA 110. In one embodiment, PTK establisher 121C establishes a new PTK by reassociating with the STA 110. For example, the AP 121 or AP 122 may disassociate with the STA 110 and may compute or derive a new PTK when the STA 110 attempts to reassociate with the AP. In one embodiment, as part of reassociating with the STA 110, the PTK establisher 121C may generate a new PMK and may compute the new PTK using the new PMK.

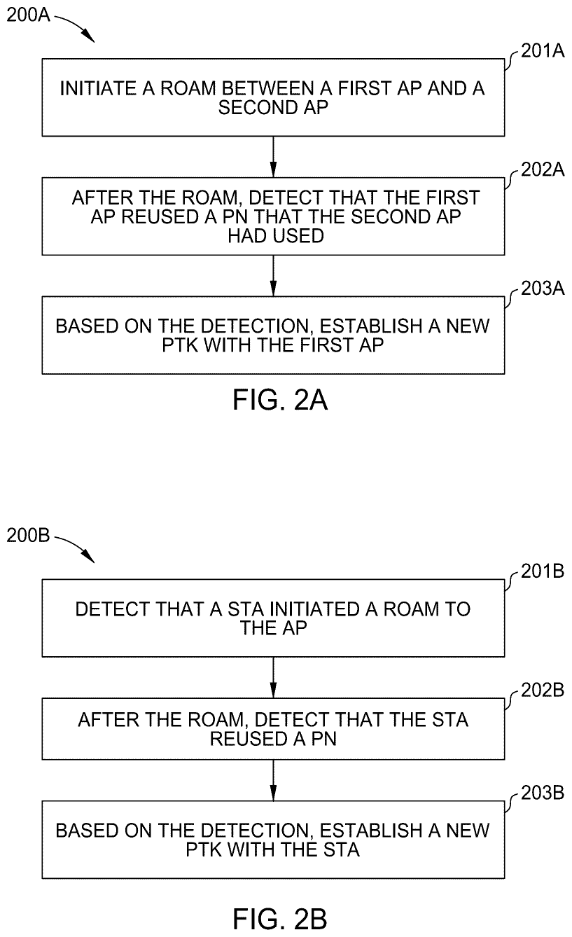

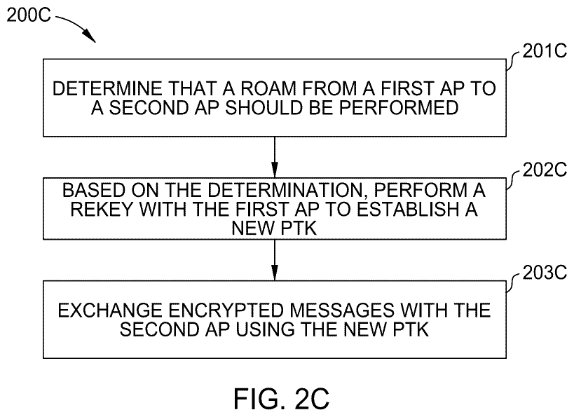

FIG. 2A illustrates a method 200A of mitigating reuse performed by a wireless device (e.g., the STA 110 of system 100 shown in FIG. 1), according to an embodiment. At block 201A, the wireless device initiates a roam between a first AP and a second AP. At block 202A, after the roam, the wireless device detects that the first AP reused a PN that the second AP had used and may detect that the reuse is not related to a retry of an earlier MPDU as allowed by a Block Ack agreement. At block 203A, based on detecting that the first AP reused the PN, the wireless device establishes a new PTK with the first AP (e.g., rekeys).

FIG. 2B illustrates a method 200B of mitigating reuse performed by an AP (e.g., the AP 121 or AP 122 of system 100 shown in FIG. 1), according to an embodiment. At block 201B, the AP detects that a STA initiated a roam to the AP. At block 202B, the AP detects after the roam that the STA reused a PN. In one embodiment, the AP may be configured to detect the reuse after it receives a state (e.g., context) for the STA from the AP that the STA was previously connected to. In one embodiment, the AP may be configured to detect the reuse when given a still-earlier association with the AP. At block 203B, based on detecting that the STA reused the PN, the AP establishes a new PTK with the STA.

FIG. 2C illustrates a method 200C of performing a rekey during roaming by a wireless device (e.g., the STA 110 of system 100 shown in FIG. 1), according to another embodiment. At block 201C, the wireless device determines that a roam from a first AP to a second AP should be performed. At block 202C, based on determining that the roam should be performed, the wireless device performs a rekey with the first AP to establish a new PTK. In one embodiment, the decision to rekey may be based on past poor experience. For example, the past poor performance may include instances where the second AP has performed PN reuse in the past, where any AP in the SMD has performed PN reuse in the past, where other metrics or heuristics suggest that APs of the SMD are at elevated risk of performing PN reuse, or where some combination of past PN reuse and elevated risk of reuse has occurred. In other embodiments, out of an abundance of caution the client may always perform rekeying before roaming. At block 203C, the wireless device exchanges encrypted messages with the second AP using the new PTK.

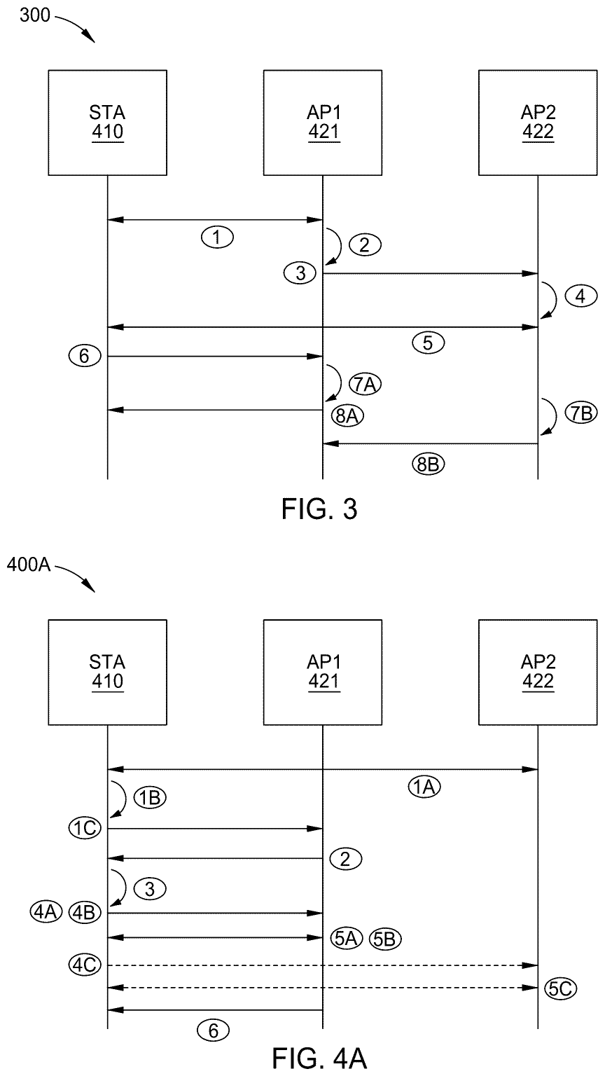

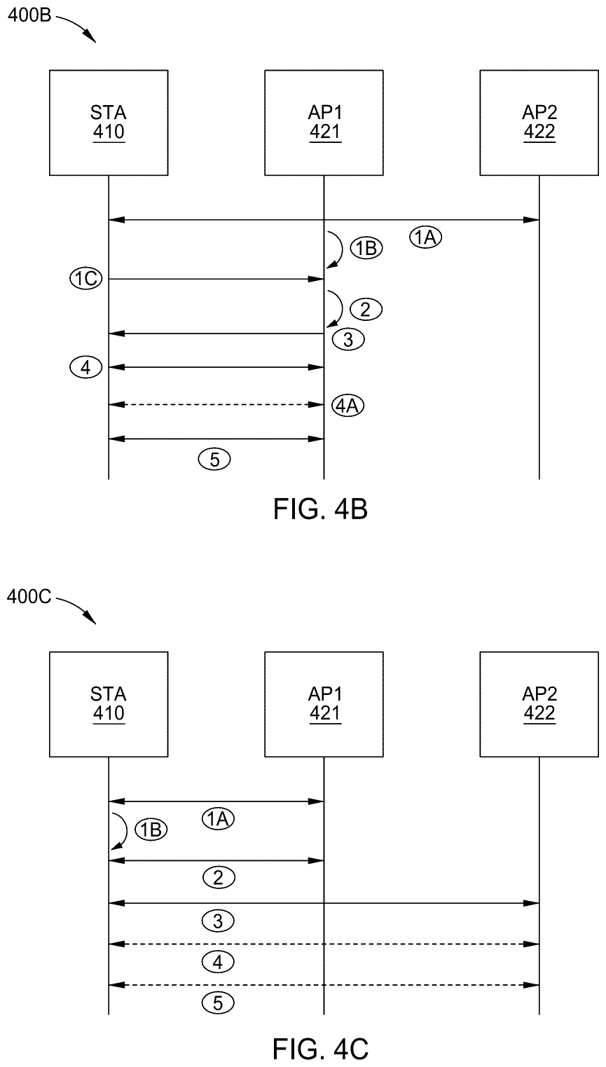

FIG. 3 illustrates a swim-lane diagram of a process 300 for an edge case that occurs during roaming, according to an embodiment. In various embodiments, the process 300 may occur at the start of process 400A,400B, or 400C of FIGS. 4A, 4B, and 4C respectively. The process 300 involves a STA 410, AP1 421, and AP2 422, which may each be one of the STAs 110 or APs (e.g., AP 121 or AP 122) of system 100 shown in FIG. 1.

At step 1, the STA 410 exchanges messages with AP1 421, which are encrypted using a PTK shared across the SMD.

At step 2, AP1 421 detects a roam initiated to AP2 422. For example, AP1 421 may detect that the STA 410 is exchanging frames with another AP in the SMD, has initiated roaming preparation, has initiated roaming execution steps, or detect some combination thereof.

At step 3, upon detecting that the roam is initiated, AP1 421 sends AP2 422 a message for determining the (downlink) PN from which AP2 422 starts counting in exchanges with the STA 410. For example, AP1 421 may add a Delta value to the last PN used prior to (e.g., shortly before) the roam. The Delta may be a fixed constant (e.g., 1024) or other buffer size value added to the last PN. In one embodiment, AP1 421 may instead transmit the last PN to AP2 422, and AP2 422 may calculate the PN to use by adding the Delta or other buffer value to the last PN received from AP1.

At step 4, AP2 422 determines the PN to start counting from in its exchange with the STA 410. For example, AP2 422 may receive the PN from AP1 421 or calculate the PN from the Delta.

At step 5, AP2 422 transmits encrypted messages to the STA 410 starting at the determined PN from step 4.

At step 6, shortly after roaming to AP2 422, the STA 410 initiates a roam back to AP1 421. For example, the STA 410 may move its location closer to AP1 421 or determine that the connection is more stable or robust at AP1 421.

At step 7A, after the STA 410 roams back to AP1 421, AP1 421 determines the PN from which to start counting in exchanges with the STA 410. If the implementation is buggy, AP1 421 may mistakenly start counting from the last PN used before the roam to AP2 422 or from 0. At step 8A, AP1 421 sends a message starting at the PN that was determined from step 7A.

While the steps 7A and 8A are being performed, AP2 422 may perform steps 7B and 8B. At step 7B, AP2 422 detects that the roam to AP1 421 was initiated by the STA 410. At step 8B, AP2 422 sends AP1 421 a message for determining the PN from which to start counting in exchanges with the STA 410. If the implementation is non-buggy, AP1 421 will exchange messages starting at the PN set by AP2 422 (e.g., assuming that PN is already incremented by Delta or similar value). Otherwise, a PN reuse may occur, and a mitigation may be performed, such as one of the mitigations provided by embodiments described herein.

It should be understood that, in some implementations, the position of AP1 421 and AP2 422 in process 300 may be reversed. For example, the edge case may instead involve the STA 410 roaming from AP2 422 to AP1 421 and back to AP2 422.

FIG. 4A illustrates a swim-lane diagram for a process 400A for mitigating a reuse during roaming, to an embodiment. Process 400A involves a STA 410, AP1 421, and AP2 422, which may each be one of the STA 110s or APs (e.g., AP 121 or AP 122) of system 100 shown in FIG. 1.

At step 1A, the STA 410 and AP2 422 exchange messages encrypted using a shared PTK of the SMD. At step 1B, the STA 410 monitors the PN. At step 1C. the STA 410 initiates a roam between AP1 421 and AP2 422. As shown in FIG. 4A, the roam between AP1 421 and AP2 422 is a roam from AP2 422 to AP1 421. However, it should be understood, that in some embodiments, the position of AP1 421 and AP2 422 may be reversed, and the roam by the STA 410 may be from AP1 421 to AP2 422. In one embodiment, steps 1A-1C are performed as part of process 300 of FIG. 3. For example, the roam initiated by the STA 410 from AP2 422 to AP1 421 in step 1C may be a roam to AP1 that occurs shortly after the STA 410 roams from AP1 421 to AP2 422. As a result, the process 400A may mitigate a scenario where the STA 410 roams away from an AP and then roams back to the AP.

At step 2, AP1 421 transmits a PN in a message to the STA 410. For example, AP1 421 increments a monotonically increasing counter and encodes the PN into an encrypted message to the STA 410.

At step 3, the STA 410 determines that there is a PN reuse. For example, the STA 410 may detect after the roam that AP1 421 reused a PN that AP2 422 has used. Based on detecting that AP1 421 reused the PN, the STA 410 proceeds to mitigate the reuse by establishing a new PTK with AP1 421.

In response to determining that there is a PN reuse, the STA 410 may perform steps 4A or 4B. In step 4A, the STA 410 disassociates with AP1 421. For example, the STA 410 may transmit a disassociation frame to AP1 421. In one embodiment, the disassociation frame may include a reason code that indicates that the AP1 421 reused the PN and is the reason for the disassociation. If the STA 410 performs step 4A, the STA 410 proceeds to step 5A. In step 5A, the STA 410 reassociates with AP1 421. During the reassociation, the STA 410 and AP1 421 establish the new PTK. For example, the new PTK may be computed from the existing PMK as part of the 4-way handshake with AP1 421. In one embodiment, the reassociation includes generating a new PMK. For example, the STA 410 and AP1 421 may reauthenticate using a pre-shared key (PSK) and an identifier for the Wi-Fi network (e.g., service set identifier (SSID)). The new PMK may then be used to compute the new PTK.

Alternative to step 4A, the STA 410 performs step 4B. In step 4B, the STA 410 transmits a rekey request to AP1 421. If the STA 410 performs step 4B, AP1 421 proceeds to step 5B. In step 5B, AP1 421 initiates the requested rekey and establishes the new PTK with the STA 410. For example, instead of performing a full reauthentication or reassociation, AP1 421 may refresh the PTK.

Alternatively, or in addition to step 4B and 5B, the STA 410 may request the rekey with AP2 422 in step 4C. If the STA 410 performs step 4C, AP2 422 proceeds to step 5C. At step 5C, AP2 422 initiates the rekey in response to the STA 410's request.

After the new PTK is established in step 5A, 5B, or 5C, the STA 410 and AP1 421 exchange messages that are encrypted using the new PTK in step 6.

FIG. 4B illustrates a swim-lane diagram for a process 400B for mitigating reuse during roaming, according to another embodiment. The process 400B involves a STA 410, AP1 421, and AP2 422, which may each be one of the STAs 110 or APs (e.g., AP 121 or AP 122) of system 100 shown in FIG. 1.

At step 1A, the STA 410 and AP2 422 exchange messages encrypted using a shared PTK of the SMD. At step 1B, AP1 421 monitors the PN used for the uplink. At step 1C, AP1 421 detects that the STA 410 initiated a roam to AP1 421. In one embodiment, steps 1A-1C may be performed as part of the process 300 shown in FIG. 3. For example, the process 400B may be a mitigation that is performed when a STA roams from AP1 421 to AP2 422 and shortly after, roams back to AP1 421.

At step 2, after the STA 410 roams to AP1 421, AP1 421 detects that the STA 410 reused the PN. For example, the STA 410 may mistakenly reset the PN counter to zero when the STA 410 connects to AP1 421.

At step 3, AP1 421 disassociates the STA 410 to establish a new PTK. For example, AP1 421 may transmit a disassociation frame to the STA 410. In one embodiment, the disassociation frame may include a reason code indicating that the PN reuse by the STA was the reason for disassociation.

At step 4, after disassociating with AP1 421, the STA 410 may reassociate with AP1 421. For example, the STA 410 may transmit an association request to AP1 421, and AP1 421 computes the new PTK during reassociation. In one embodiment, the reassociation includes generating a new PMK for computing the new PTK.

Alternative to step 3 and step 4, the STA 410 may perform step 4A to establish the new PTK. At step 4A, the STA 410 performs a rekey to refresh the PTK.

After the new PTK is established in step 4 or 4A, the STA 410 and AP1 421 exchange messages that are encrypted using the new PTK at step 5.

FIG. 4C illustrates a swim-lane diagram for a process 400C for establishing a new PTK during roaming, according to an embodiment. The process 400C involves a STA 410, AP1 421, and AP2 422, which may each be one of the STAs 110 or APs (e.g., AP 121 or AP 122) of system 100 shown in FIG. 1.

At step 1A, AP1 421 and the STA 410 exchange messages encrypted using a shared PTK of the SMD. At step 1B, the STA 410 determines that a roam should be initiated. In one embodiment, steps 1A and 1B are performed as part of the process 300 of FIG. 3. For example, the STA 410 may initiate a roam from AP2 422 to AP1 421 prior to the process 400C and may determine that a roam back to AP2 422 should be initiated. For example, shortly after roaming to AP1 421, the STA 410 may determine that the connection is weaker or less stable than its connection with AP2 422.

At step 2, based on determining that the roam to AP2 422 should be performed, the STA 410 performs a rekey with AP1 421. For example, the STA 410 may request a rekey with AP1 421 prior to roaming to AP2 422. By performing the rekey, a new PTK is established. At step 3, the STA 410 roams to AP2 422 and encrypts messages of the STA 410 using the new PTK.

In some embodiments, steps 4 and 5 may be additionally performed after the roam to AP2 422. At step 4, the STA 410 performs a rekey with AP2 422 to establish a second new PTK. At step 5, the STA 410 and AP2 422 exchange messages that are encrypted using the second new PTK. In some embodiments, performing the rekey both before and after the roam advantageously mitigates potential reuses whether AP1 421 or AP2 422 is the source of the reuse.

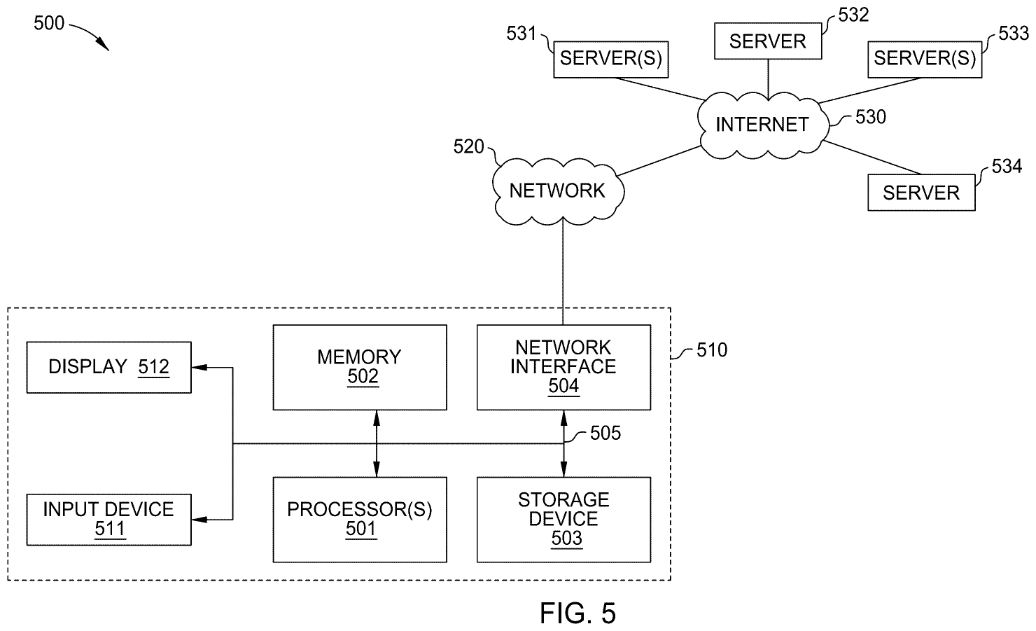

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Any of the systems or devices described above, including the STA 110, the AP 121, and the AP 122 shown in FIG. 1, may be implemented using an instance of the computer system 510. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network (e.g., an Extranet or the Internet) on servers 532-534. One or more of servers 532-534 may also reside in a cloud computing environment, for example.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless device comprising:
one or more memories; and
one or more processors communicatively coupled to the one or more memories, wherein the one or more processors are configured, individually or collectively, to perform an operation comprising:
initiating a roam between a first access point (AP) and a second AP;
detecting, after the roam, that the first AP reused a packet number (PN) that the second AP had used; and
based on detecting that the first AP reused the PN, establishing a new pairwise transient key (PTK) with the first AP.

2. The wireless device of claim 1, wherein establishing the new PTK comprises requesting a rekey with at least one of the first AP or the second AP.

3. The wireless device of claim 1, wherein establishing the new PTK comprises:
disassociating from the first AP; and
reassociating with the first AP.

4. The wireless device of claim 3, wherein disassociating from the first AP comprises communicating, to the first AP, a message indicating the first AP reused the PN.

5. The wireless device of claim 3, wherein reassociating with the first AP establishes a new pairwise master key (PMK) with the first AP.

6. The wireless device of claim 1, wherein the operation further comprises roaming from the first AP to the second AP, wherein initiating the roam between the first AP and the second AP comprises initiating the roam from the second AP back to the first AP.

7. The wireless device of claim 1, wherein the operation further comprises:
determining that a number of PN reuses exceeds a threshold; and
based on the determining that the number of PN reuses exceeds the threshold, opting out of roaming.

8. An access point comprising:
one or more memories; and
one or more processors communicatively coupled to the one or more memories, wherein the one or more processors are configured, individually or collectively, to perform an operation comprising:
detecting that a station (STA) initiated a roam to the access point (AP);
detecting, after the roam, that the STA reused a PN; and
based on the detecting that the STA reused the PN, establishing a new PTK with the STA.

9. The access point of claim 8, wherein establishing the new PTK comprises:
disassociating with the STA;
receiving a reassociation request from the STA; and
in response to receiving the reassociation request, reassociating with the STA and deriving the new PTK.

10. The access point of claim 9, wherein dissociating with the STA comprises:
sending a message to the STA indicating that the STA reused the PN.

11. The access point of claim 9, wherein reassociating with the STA establishes a new PMK with the STA.

12. The access point of claim 8, wherein establishing the new PTK comprises:
initiating a rekey with the STA.

13. The access point of claim 8, wherein detecting that the STA reused the PN after the roam to the AP comprises:
after detecting that the STA initiated a roam to the AP, determining a first PN;
after the STA roams to the AP, receiving a second PN from the STA; and
detecting a PN reuse if the second PN is less than the first PN.

14. The access point of claim 13, wherein determining the first PN comprises:
receiving the first PN from a second AP;
wherein prior to the STA roaming to the AP, the second AP calculates the first PN based on a Delta value.

15. The access point of claim 13, wherein determining the first PN comprises:
calculating the first PN by adding a Delta value to a PN received from a second AP.

16. The access point of claim 13, wherein the operation further comprises:
receiving messages from a second AP through an out-of-band communication channel after the first PN.

17. The access point of claim 8, wherein prior to the roam to the AP, the STA roams from the AP to a second AP.

18. A wireless device comprising:
one or more memories; and
one or more processors communicatively coupled to the one or more memories, wherein the one or more processors are configured, individually or collectively, to perform an operation comprising:
determining that a roam from a first access point (AP) to a second AP should be performed;
based on determining that the roam should be performed, performing a rekey with the first AP to establish a new PTK; and
exchanging encrypted messages with the second AP using the new PTK.

19. The wireless device of claim 18, wherein the operation further comprises:
after the roam is performed, performing a rekey with the second AP to establish a second new PTK; and
exchanging encrypted messages with the second AP using the second new PTK.

20. The wireless device of claim 18, wherein the operation further comprises:
roaming from the second AP to the first AP;
wherein determining that the roam from the first AP to the second AP should be performed comprises detecting that a roam back to the second AP is imminent.
